(19) United States
(12) Patent Application Publication
(10) Pub. No.: US 2025/0291548 A1
(43) Pub. Date: Sep. 18, 2025

(54) REPRODUCIBLE FLOATING-POINT STOCHASTIC ROUNDING

(71) Applicant: MELLANOX TECHNOLOGIES, LTD., Yokneam (IL)

(72) Inventors: Roee Levy Leshem, Tel-Aviv (IL); Jonah Matthew Alben, San Jose, CA (US); Ming Yiu Siu, Santa Clara, CA (US); Daniel Segalovich, Ramat Gan (IL); Itamar Rabenstein, Petach-Tiqwa (IL); Noam Michaelis, Kfar-Saba (IL); Ofir Klara Altshul, Herzliya (IL); Aviv Avraham Paxton, Petah-Tikva (IL)

(21) Appl. No.: 18/605,549

(22) Filed: Mar. 14, 2024

(51) Int. Cl. G06F 7/499; G06F 7/483

(52) U.S. Cl. CPC G06F 7/49947; G06F 7/483

(57) ABSTRACT

Systems, devices, and methods are provided. In one example, a system is described that includes circuits to receive a plurality of numbers at a first computing system, perform an operation on the plurality of numbers to generate a number, and use the generated number to perform stochastic rounding of a floating point number to generate a stochastically rounded floating point number.

### FIELD OF THE DISCLOSURE

The present disclosure is generally directed toward networking and, in particular, toward networking devices and methods of operating the same.

### BACKGROUND

Switches and similar network devices represent a core component of many communication, security, and computing networks. Switches are often used to connect multiple devices to form networks.

Devices including but not limited to personal computers, servers, central processing units (CPUs), graphics processing units (GPUs), and other types of computing devices, may be interconnected using network devices such as switches. Such interconnected entities may form a network enabling data communication and resource sharing among the nodes. Switches and other computing devices may be enabled to provide computational services, such as reduction and/or aggregation calculations, for host devices.

For example, during training of machine learning networks done with in-network algorithms for reduction and aggregation, vectors of floating-point operands are added or multiplied with higher precision than the operands sent by the host. After the calculation ends, a rounding operation may be needed. Stochastic rounding is crucial for training process as it introduces controlled randomness, reduces bias and variance, improves generalization, and enhances robustness.

In standard rounding techniques, values are typically rounded to the nearest representable number within a certain precision. For instance, in rounding to the nearest integer, 2.3 becomes 2, and 2.5 becomes 3. This can introduce a consistent bias in one direction, especially when dealing with a large number of calculations. Other rounding techniques, such as round to nearest even (RNE) in which numbers are rounded to the nearest even number, also introduce bias which can be unacceptable for particular types of applications.

With stochastic rounding, a number is randomly rounded up or down instead of always rounding to the nearest number. The probability of the number being rounded up or down may be proportional to the distance of the number from the two nearest representable numbers. For example, a number of 2.3, may have a 30% chance of being rounded up to 3 and a 70% chance of being rounded down to 2.

An advantage of stochastic rounding is that systematic bias over many rounding operations is reduced. While each individual rounding operation may introduce an error, the errors do not systematically bias upwards or downwards. Over a large number of operations, such errors tend to average out, making stochastic rounding particularly useful in iterative processes like numerical optimization or machine learning.

In machine learning, particularly in training deep neural networks, stochastic rounding can be valuable when working with low-precision arithmetic, such as 16-bit or 8-bit floating-point numbers. Stochastic rounding helps in maintaining the accuracy of a model despite the reduced precision by preventing the accumulation of rounding errors that could otherwise lead to significant biases or convergence issues.

### BRIEF SUMMARY

In accordance with one or more embodiments described herein, a computing system, such as a switch, may enable a diverse range of systems, such as switches, servers, personal computers, and other computing devices, to communicate across a network. Ports of the computing system may function as communication endpoints, allowing the computing system to manage multiple simultaneous network connections with one or more nodes. The computing system, which may be referred to herein as a switch, may perform one or more methods involving the stochastic rounding of results of calculations. Such stochastic rounding may, through the systems and methods described herein, be performed in a reproducible manner.

Reproducibility, the ability to consistently duplicate the results of an experiment or calculation, is a critical aspect in computational processes, such as AI model training performed by hosts using a switch or other computing device to perform calculations. In such scenarios, reproducibility offers several significant benefits. For example, in AI and machine learning, validating the results helps ensure that models are accurate and reliable. Developers can more quickly work through errors occurring during training when rounding results are reproducible. Reproducibility aids in identifying and rectifying errors in AI calculations. For example, if results can be consistently reproduced, it becomes easier to pinpoint where and why errors occur, whether in the data, algorithm, or implementation.

The present disclosure describes systems and methods for enabling a switch or other computing system to perform reduction calculations on numbers received from one or more hosts, generate a random or pseudorandom number in a reproducible manner, and use the generated number to stochastically round the results of the reduction calculations.

Conventional methods of stochastic rounding do not provide for reproducibility. Reproducibility of the rounding is needed to allow users to maintain snapshots and perform debugging with the exact same training process. The systems and methods described herein enable stochastic rounding of high precision floating-point numbers to lower precision numbers while allowing for the reproducibility of the operation given the fact that addition in AI switches is done in the bus of multiple orthogonal operands.

One or more of the systems and methods described herein may be used as part of an iterative training process. During the training, one or more sets of numbers may arrive on a bus. When rounding of a number is necessary, a random number may be generated based on one or more of the numbers on the bus, such as by using a bit manipulation scheme. The generated random number may then be used to perform stochastic rounding. Since the same set of numbers may arrive on the bus on each iteration of the training process, the random number can be later reproduced, such as for troubleshooting purposes.

Some users may also demand stochastic behavior, for example when the user sends the operands they want to be used to perform the operations. As an example, an issue occurs when a host sends a 16-bit floating point (FP16) number and the switch performs a calculation in a 32-bit floating point (FP32). When converting back the higher precision numbers to lower precision, some rounding must occur. There are multiple rounding algorithms. While most rounding algorithms are deterministic, in machine learning operations there may be a need for stochastic behavior. However, conventional stochastic rounding is not reproducible. Also, random number generators are difficult to implement in hardware. The systems and methods described herein provide a way to generate random numbers in hardware and in a reproducible manner.

While the examples provided herein refer to FP16 and FP32, it should be appreciated that implementations described herein may be used for any format of number, including, for example, IEEE half- and/or single-precision floating point numbers. For example, a host may send IEEE half-precision floating point numbers and a switch may compute in IEEE single-precision floating point numbers.

As an illustrative example aspect of the systems and methods disclosed, a method of providing stochastic rounding, may include receiving a plurality of numbers at a first computing system; performing an operation on the plurality of numbers to generate a number; and using the generated number to perform stochastic rounding of a floating point number to generate a stochastically rounded floating point number.

The above example aspect includes any one or more of wherein the received plurality of numbers are orthogonal numbers, wherein the plurality of numbers is received from one or more processing circuits, and wherein the one or more processing circuits are enabled to reproduce the generated number used to perform the stochastic rounding, wherein the processing circuits provide the plurality of numbers during a reproducible operation, wherein the first computing system performs a floating point operation on the plurality of numbers, wherein a result of the floating point operation is of a higher precision than each of the received plurality of numbers, wherein the stochastic rounding is a rounding of the result of the floating point operation, wherein each of the received plurality of numbers comprises a stream of bits arriving at a bus, wherein the bus stores each of the plurality of numbers, wherein each of the plurality of numbers comprises multiple digits or bits, wherein generating the number comprises reading one or more bits from each of the numbers from a bus and using a logic function to combine the one or more bits from each of the numbers, wherein generating the number comprises reading a plurality of bits from each of the numbers from a bus and using a logic function to combine the plurality of bits from each of the numbers, wherein generating the number comprises reading one or more bits from each of the numbers from a bus and using a using a multiplexer to combine the one or more bits from each of the numbers, wherein the operation comprises using one or more logic gates, wherein the operation is reproducible based on the received plurality of numbers, wherein the operation is performed by a hardware logical circuit, and wherein the method further comprises transmitting the stochastically rounded floating point number to one or more second computing systems over a communication channel.

In another illustrative example, a communication system includes a plurality of ports and one or more circuits to: receive a plurality of numbers at a first computing system; perform an operation on the plurality of numbers to generate a number; and use the generated number to perform stochastic rounding of a floating point number to generate a stochastically rounded floating point number.

The above example aspect includes one or more of wherein the received plurality of numbers are orthogonal numbers, wherein the plurality of numbers is received from one or more processing circuits, wherein the one or more processing circuits are enabled to reproduce the generated number used to perform the stochastic rounding, and wherein the processing circuits provide the plurality of numbers during a reproducible operation. In yet another illustrative example, a switch includes one or more circuits to: receive a plurality of numbers at a first computing system; perform an operation on the plurality of numbers to generate a number; and use the generated number to perform stochastic rounding of a floating point number to generate a stochastically rounded floating point number.

The rounding approaches depicted and described herein may be applied to a switch, a router, or any other suitable type of networking device or general computing device known or yet to be developed. Additional features and advantages are described herein and will be apparent from the following description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a computing system in accordance with at least some embodiments of the present disclosure;

FIG. 2 illustrates a network of a computing system and hosts in accordance with at least some embodiments of the present disclosure;

FIG. 3 is a block diagram depicting an illustrative configuration of a computing system in communication with hosts in accordance with at least some embodiments of the present disclosure;

FIG. 4A illustrates vectors of data in accordance with at least some embodiments of the present disclosure;

FIG. 4B illustrates vectors of data in accordance with at least some embodiments of the present disclosure;

FIG. 5 is a first flow diagram depicting a method in accordance with at least some embodiments of the present disclosure; and

FIG. 6 is a second flow diagram depicting a method in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

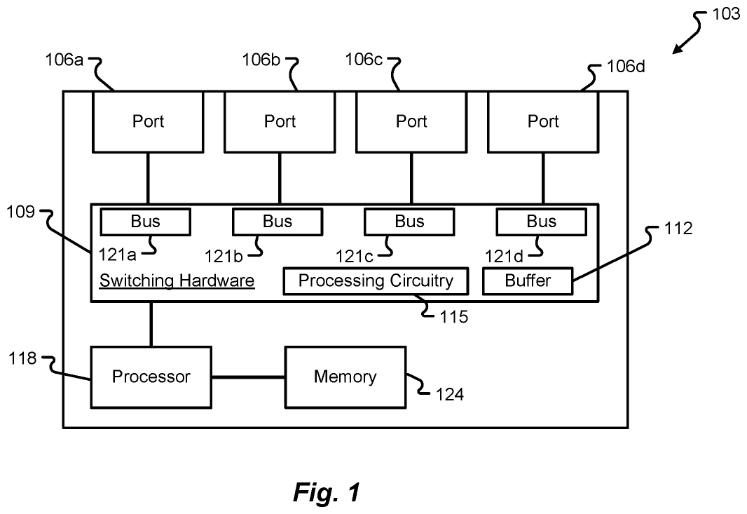

Referring now to FIGS. 1-6, various systems and methods for providing reproducible stochastic rounding will be described. The concepts of rounding depicted and described herein can be applied to the rounding of numbers resulting from reduction operations as well as rounding of any other numbers. The implementations described below relate to specific examples in which host devices utilize a switch for computational purposes and the switch returns a rounding result of the computations. However, it should be appreciated that the same or similar systems and methods may be used for a variety of other purposes, including any scenario in which a computing device has access to a plurality of numbers and seeks to round a number.

The term data as used herein should be construed to mean any suitable discrete amount of digitized information. The data being received by the switch or other device may be in the form of packetized or non-packetized data without departing from the scope of the present disclosure. Furthermore, certain embodiments will be described in connection with a system that is configured to receive data from hosts and perform a reduction of the received data. It should be appreciated, however, that in certain implementations of the disclosed systems and methods, no hosts may be required. It should be appreciated that the features and functions of the systems and methods described herein may be utilized in a centralized architecture, a distributed architecture, or within a single computing device.

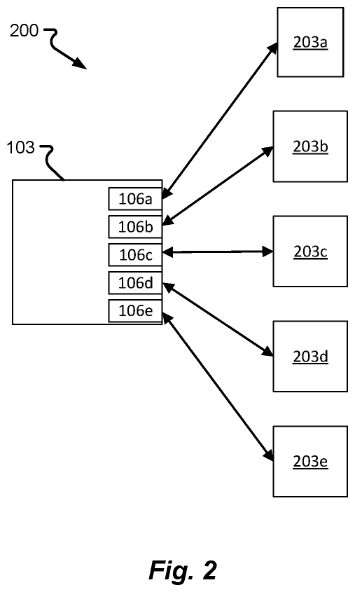

As illustrated in FIG. 1, a switch 103 as described herein may be a computing system comprising a number of ports 106a-d which may be used to interconnect with other switches 103 and/or host devices such as other computing systems and network devices to make up a network. For example, and as illustrated in FIG. 2, a switch 103 may be in communication with a plurality of hosts 203a-e via ports 106a-e. Such a network 200 of switch-connected hosts may be useful in various settings, from data centers and cloud computing infrastructures to artificial intelligence systems.

Switches 103, as described in greater detail herein, may enable communication between switches 103 and/or hosts 203. A switch 103 may be, for example, a switch, a network interface controller (NIC), or other device capable of receiving and sending data, and may act as a central node in the network. Switches 103 may be wired in a topology including spine switches, top-of-rack (TOR) switches, and/or leaf switches, for example. Switches 103 may be capable of receiving, processing, and forwarding data, e.g., packets, to appropriate destinations within the network, such as other switches 103 and/or hosts 203. In some implementations, a switch 103 may be included in a switch box, a platform, or a case which may contain one or more switches 103 as well as one or more power supply devices and other components.

In some implementations, a switch 103 may be capable of providing computational capabilities and performing calculations for one or more hosts 203. Such a switch 103 may be equipped with one or more arithmetic logic units (ALUs), central processing units (CPUs), graphics processing units (GPUs), application-specific integrated circuits (ASICs), and/or field programmable gate arrays (FPGAs) to handle computational tasks for hosts 203.

The hosts 203 in the network 200 may be individual workstations, servers, or IoT devices that generate or collect large volumes of data. Such hosts 203 may utilize the switch 103 to offload reduction tasks to minimize computational load and to process data more efficiently. A reduction task as described herein may include operations such as summing values, finding minimum or maximum values, or combining data sets. The switch 103 may utilize one or more processing circuits 115, such as ALUs to, upon receiving data from one or more hosts 203, perform the required reduction operations. The result of the operations may, as described above, require rounding. In such a scenario, the switch 103 may be configured, using the systems and methods described herein, to perform a stochastic rounding of the result of the operation and return the rounded result to one or more of the hosts 203. Using a rounding method as described herein, the rounded result can be reproduced in later iterations and will not introduce a rounding bias which may conflict with results of computationally heavy tasks such as the training of AI models.

In some implementations, a switch 103 may comprise one or more ports 106a-c connected to one or more ports of other switches 103 and/or hosts 203. Processes, such as applications executed by the hosts 203 may involve transmitting data to the switch 103 for reduction purposes. Data may flow through the network of switches 103 and hosts 203 using one or more protocols such as transmission control protocol (TCP), user datagram protocol (UDP), or Internet protocol (IP), for example. A switch 103 may, upon receiving data from a host 203 or another switch 103 examine the data to identify a computation required for the data, perform the computation, round a result of the computation, and route the rounded result of the computation as data through the network.

Each host 203 may be a computing unit, such as a personal computer, server, or other computing device, and may be responsible for executing applications and performing data processing tasks. Hosts 203 as described herein may range from servers in a data center to desktop computers in a network, or to devices such as internet of things (IoT) sensors and smart devices, as examples.

Each host 203 may for example include one or more processing circuits, such as GPUs, CPUs, ASICs, FPGAs, or other circuitry capable of performing computations, as well as memory and storage resources to run software applications, handle data processing, and perform specific tasks as required. In some implementations, hosts 203 may also or alternatively include hardware such as GPUs for handling intensive tasks for machine learning, artificial intelligence (AI) workloads, or other complex processes.

For example, hosts 203 utilizing switches 103 may operate as a high-performance computing (HPC) cluster. A cluster of hosts 203 may comprise numerous interconnected servers, each equipped with CPUs and/or GPUs. The hosts 203 may provide computational horsepower for, as an example, training large-scale AI models or running complex scientific simulations. For AI and machine learning tasks, the hosts 203 may comprise one or more GPUs or other processing circuitry which may be capable of handling parallel processing requirements of neural networks and other applications.

Hosts 203 may be client devices which, for example, engage in AI-related, research-related, and other processor-intensive tasks, and utilize a network of switches 103 and other hosts 203 to handle computational loads and data throughput required by such intensive applications. Such hosts 203 may include, for example, workstations and personal computers used by researchers, data scientists, and professionals for developing, testing, and running AI models and research simulations.

A switch 103 as described herein may in some implementations be as illustrated in FIG. 1. Such a switch 103 may include a plurality of ports 106a-d, busses 121a-d, switching hardware 109, buffer(s) 112, processing circuitry 115, processors 118, and memory 124. The ports 106a-d of a switch 103 may be capable of facilitating the transmission of data packets, or non-packetized data, into, out of, and through the switch 103. Such ports 106a-d may serve as interface points where network cables may be connected, connecting the switch 103 with other switches 103, and/or hosts 203.

Each port 106 may be capable of receiving incoming data packets from other devices and/or transmitting outgoing data packets to other devices. In some implementations, ports 106 may be configured to operate as either dedicated ingress or egress ports 106 or may be enabled to operate in a dual functionality capable of performing ingress and egress functions. For example, an egress port 106 may be used exclusively for sending data from the switch 103 and an ingress port 106 may be used solely for receiving incoming data into the switch 103.

Switching hardware 109 of a switch 103 may be capable of handling a received packet by performing ingress processing, reduction calculations, generating a random or pseudo-random number, using the generated number to round a result of the reduction calculations, and performing egress processing of the rounded result of the reduction calculations. Using a system or method as described herein, switching hardware 109 may be capable of providing reduction computation capabilities for one or more hosts 203 in using stochastic rounding in a reproducible manner.

Each port 106a-d of a switch 103 may be associated with one or more buses 121a-d. When data, such as a vector, a stream of numbers, or data in any format, is received via a port 106a-d, the data may be stored in a respective bus 121a-d associated with the port 106a-d. The data, in the form of numbers, appearing on the bus(es) may be used both for reduction computations as well as the generation of numbers to be used to round the results of the reduction computations.

Switching hardware 109 of a switch 103 may include processing circuitry 115. Processing circuitry 115 may enable the switch 103 to perform computational tasks. In some implementations, processing circuitry 115 may include arithmetic logic units (ALUs), however in some implementations other circuits may be used. Processing circuitry 115 as described herein may be capable of performing a variety of arithmetic operations such as addition and/or subtraction as well as logic operations (such as AND, OR, NOT, etc.).

The processing circuitry 115 within the switch 103 may enable the switch to execute computational tasks, such as on behalf of one or more hosts. Such tasks may range from simple arithmetic calculations to more complex logical decision-making processes.

In support of the functionality of the switching hardware 109, one or more processors 118 may be configured to control aspects of the switching hardware 109. The processor 118 may in some implementations include a CPU, an ASIC, and/or other processing circuitry which may be capable of handling computations, decision-making, and management functions required for operation of the switch 103.

A processor 118 may be configured to handle management and control functions of the switch 103, such as setting up routing tables, configuring ports, and otherwise managing operation of the switch 103. A processor 118 of the switch may execute software and/or firmware to configure and manage the switch 103, such as an operating system and management tools.

Memory 124 of a switch 103 as described herein may comprise one or more memory elements capable of storing configuration settings, application data, operating system data, and other data. Such memory elements may include, for example, random access memory (RAM), dynamic RAM (DRAM), flash memory, non-volatile RAM (NVRAM), ternary content-addressable memory (TCAM), static RAM (SRAM), and/or memory elements of other formats.

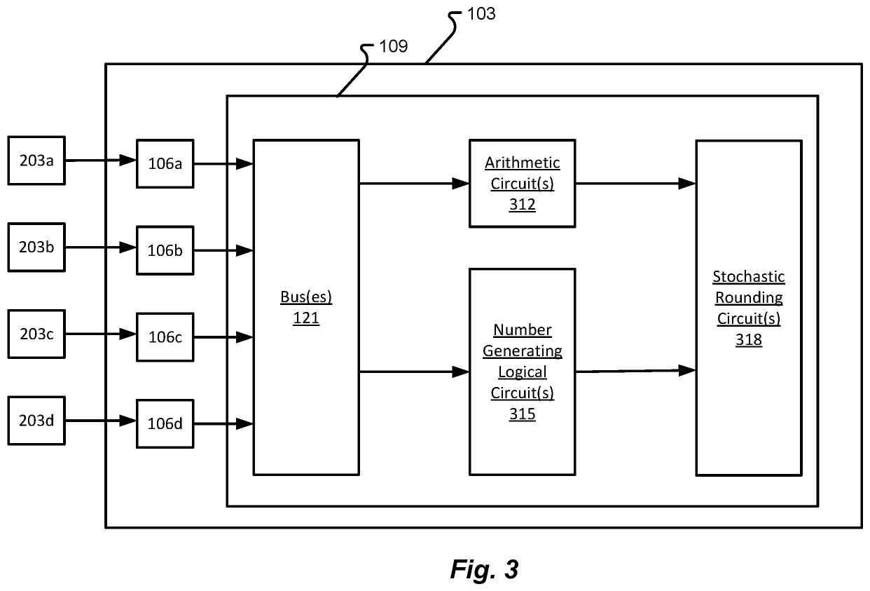

As illustrated in FIG. 3, a plurality of hosts 200a-d may send streams of data to a switch 103. As described above, each host 200a-d may utilize the switch 103 to perform operations such as reduction operations. The hosts 200a-d may, for example, utilize computational capabilities of the switch 103 to aggregate data to derive a single result, such as through summing, finding minimum or maximum values, or combining data sets. The data sent from the hosts 200a-d to the switch 103 may be raw data which the switch 103 may reduce.

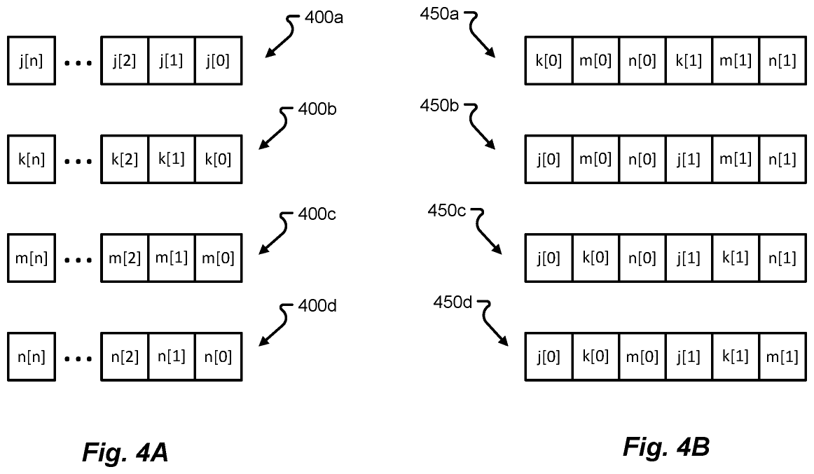

A host 203 as described herein may be referred to as a processing circuit. The hosts 203 may provide a plurality of numbers to the switch 103 via one or more communication channels during a reproducible operation. The streams of data from each host 203a-d may be received by the switch 103 via a respective port 106a-d. As described below, streams of data sent from hosts 203a-d may in some implementations be in the form of vectors 400a-d as illustrated in FIG. 4A.

As illustrated in FIG. 4A, a vector 400a-d may include n+1 numbers. The vectors illustrated in FIG. 4A include a first vector 400a including numbers j [0] to j [n], a second vector 400b including numbers k [0] to k [n], a third vector 400c including numbers m [0] to m [n], and a fourth vector 400d including numbers n [0] to n [n]. While each of the vectors 400a-d of FIG. 4A are illustrated as including the same number of numbers, it should be appreciated that each vector 400a-d may be of a particular length or size and may be the same size or different size.

The numbers received from each host 200a-d may be orthogonal numbers. Orthogonal numbers as described herein may refer to numbers that are mathematically independent of each other in the context of vector spaces. Each vector in an orthogonal set may provide unique information that is not redundant with respect to the information provided by other vectors in the set.

From the port 106a-d, the received data may be written to a bus 121 of the switching hardware 109 of the switch 103. While illustrated in FIG. 3 as a single bus 121, it should be appreciated that in some implementations each port 106a-d may be associated with a respective bus 121a-d such as illustrated in FIG. 1.

The numbers received from hosts 203a-d appearing on the bus(es) 121 may be processed in parallel. Processing may be performed by processing circuitry 115 which, as described above, may include one or more ALUs.

Each ALU may process numbers appearing on the bus(es) 121 by performing calculations in parallel. As illustrated in FIG. 3, the processing circuitry 115 may include one or more arithmetic circuits 312, one or more number generating logical circuits 315, and one or more stochastic rounding circuits 318. While illustrated in FIG. 3 as being separate circuits, it should be appreciated that at least in some implementations each of the arithmetic circuits 312, number generating logical circuits 315, and stochastic rounding circuits 318 may be functions performed by one or more ALUs or other types of processing circuitry 115.

After reaching the bus(es) 121, the data may be handled in a number of ways. An arithmetic circuit 312 may perform an operation such as a reductive operation. The operation performed by the arithmetic circuit(s) 312 may be based on instructions received from a host having sourced the data appearing on the bus. For example, each host 203 may transmit a vector to the switch 103 and request the switch 103 to perform an operation using the vector. Such an operation may include summing the contents of the vector, summing a plurality of vectors from one or more hosts 203 together, or some other function. While add is used herein as an example logical operation, it should be appreciated that other logical functions or arithmetical algorithms may be implemented, such as a floating point multiplication.

The operation performed by the arithmetic circuit 312 may be a floating point operation. For example, the bus(es) 121 may receive one or more vectors containing multiple floating point numbers. To perform the operation, the arithmetic circuit 312 may convert each floating point number into a floating point number with a higher precision. This conversion may enable the arithmetic circuit 312 to accurately perform the operation and minimize error during the operation.

Once the numbers are in a higher precision floating point format, the arithmetic circuit 312 may perform the operation, such as an addition or multiplication operation. As an example, the arithmetic circuit 312 may iteratively add each higher precision floating point number to an accumulator.

After performing the operation, the arithmetic circuit 312 may output the result to a stochastic rounding circuit 318 to round the higher precision floating point result back to a lower precision floating point number. As described above, each of the arithmetic circuit(s) 312, the number generating logical circuit(s) 315, and the stochastic rounding circuit(s) 318 may be separate circuits or may be processes executed by a single unit such as an ALU.

To enable the stochastic rounding circuit(s) 318 to perform stochastic rounding, the stochastic rounding circuit(s) 318 may be fed a number from a number generating logical circuit 315. The number generating logical circuit 315 may be configured to generate a random number using one or more of the numbers on the bus 121.

The number generating logical circuit 315 may be configured to perform a function using contents of the bus(es) 121 to create a reproducible but random number. The number generating logical circuit 315 may in some implementations utilize a multiplexer or other logic function to combine the extracted digits into a single number. As an example, generated numbers 450a-d illustrated in FIG. 4B may be created from the set of vectors 400a-d illustrated in FIG. 4A. To generate a number to be used to stochastically round a result of an operation performed on the vector 400a, the number generating logical circuit 315 may extract a first bit from each of vectors 400b-d, followed by a next bit from each of vectors 400b-d, until a number of a particular number of bits is generated. The bit extracted from each vector 400b-d may be taken from mantissa or an exponent of numbers in the vectors 400b-d. In the examples illustrated in FIG. 4B, six digit numbers are generated, however it should be appreciated that numbers of any length may be generated using the same or similar methods. Furthermore, other reproducible methods of creating a number from sets of vectors appearing on a bus may be used in other implementations. This method can be used to provide stochastic rounding of any number given a set of other numbers. Instead of vectors, it can be streams of numbers. The numbers used to create the number may be independent of the numbers used to compute the number being rounded, avoiding the possibility of some correlation between the rounded numbers.

Once a number is generated using the number generating logical circuit 315, the generated number may be supplied to the stochastic rounding circuit 318. Next, the result of the arithmetic circuit 312 may be stochastically rounded by the stochastic rounding circuit 318 using the number generated by the number generating logical circuit 315.

As a result of the rounding process, the rounding may be reproducible as long as the process is started from the same memory snapshot. For example, the seed used to create the random or pseudorandom number used to perform the stochastic rounding may be determined based on the number appearing on the bus.

This feature may be helpful when hosts are performing large computing tasks, such as ML-related tasks. Such hosts may compute until hitting an error, then roll back to an earlier memory snapshot, make an adjustment, and continue on. Since the stochastic rounding is performed in the same way, only the adjustment is changed and the users operating the host can more accurately evaluate the adjustment.

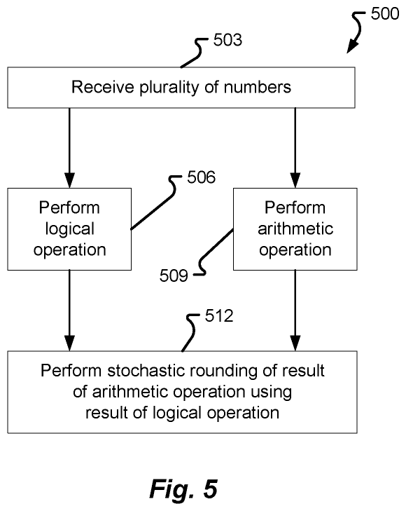

As illustrated in FIG. 5, a switch 103, or other computing device, may perform a method 500 of performing stochastic rounding of a result of an arithmetic operation using a number generated as a result of a logical operation. The method 500 may begin at 503 when the switch 103 receives data in the form of a plurality of numbers, such as one or more vectors, from one or more hosts.

As described above, the numbers may be received by the switch 103 from one or more processing circuits (such as hosts 203a-d). Each of the received plurality of numbers may comprise a stream of bits arriving at a bus 121 of the switch 103. For example, the switch 103, upon receiving numbers at a port 106, may store the numbers in a bus 121. Each number may comprise single or multiple digits. The numbers may be received from a plurality of hosts 203 and the numbers from each host 203 may be orthogonal to numbers from other hosts 203.

At 506, the switch 103 may perform a logical operation on the plurality of numbers to generate a random or pseudorandom number. Generating the random or pseudorandom number may be performed in a number of ways in different implementations. In one example, the switch 103 may extract one or more digits from each number on the bus and combine the extracted digits using, for example, a multiplexer or other logic function into a single number. As illustrated in FIGS. 4A and 4B, vectors 400a-d appearing on a bus may result in numbers 450a-d.

The operation performed to generate the number should be reproducible such that when the same numbers appear on the bus, the same number is generated. In this way, the stochastic rounding described below which relies on the generated number can likewise be reproduced.

In some implementations, the numbers combined to generate the random or pseudorandom number may not include any of the numbers which are to be used in the arithmetic operation described below, the result of which is to be rounded using the generated random or pseudorandom number. For example, as illustrated by FIGS. 4A and 4B, the number 450a does not include any of the contents of the vector 400a.

At 509, the switch 103 may perform an add, or other arithmetic operation, on one or more of the numbers appearing on the bus. Such an operation may be, for example, a floating point add operation or a logic gate such as XOR, shift, etc. The arithmetic operation may be performed by a hardware logical circuit such as an ALU or other circuit.

The arithmetic operation may be requested by one or more of the hosts 203 which supplied the numbers appearing on the bus. For example, a host 203 may transmit a vector to the switch 103 and the switch 103 may sum the contents of the vector. In some implementations, the switch 103 may sum the contents of a plurality of vectors from a plurality of hosts 203 and return the total sum to one or more of the hosts 203.

A result of the arithmetic operation may be of a higher precision than each of the received numbers. For example, the received numbers may be in floating point 8 (FP8) or FP16 and the arithmetic operation may be performed in FP16 or FP32. The result of the arithmetic operation may thus be of a higher precision than the received numbers. For this reason, rounding may be required.

At 512, the switch 103 may use the generated number to perform stochastic rounding of the result of the arithmetic operation to generate a stochastically rounded version of the result of the arithmetic operation.

In some implementations, to perform stochastic rounding, the system may add the random number to the number to be rounded and then round down. As a result, numbers closer to one will be more likely to be rounded up and numbers closer to zero will be more likely to be rounded down.

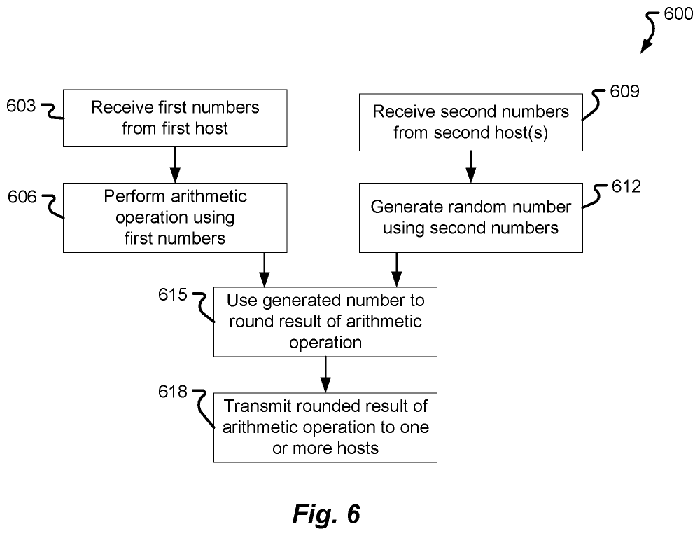

FIG. 6 illustrates an example method 600 of a switch 103 performing a computation for a first host using the systems and methods described herein. In the example method 600, a first host 203a sends a first set of numbers to the switch 103 and expects to receive a sum of numbers of the first set of numbers from the switch 103. Each of three other hosts 203b-d send a set of numbers to the switch 103. The numbers of the first set of numbers are orthogonal to the numbers of the three other sets of numbers. As described below, the switch 103 performs the sum of the first set of numbers, uses the three other sets of numbers to generate a random or pseudo-random number, uses the generated number to perform stochastic rounding of the sum, and returns the rounded sum to the first host 203a.

As should be appreciated, many variations of the method 600 may be implemented depending on demands of the hosts 203a-d. For example, the switch 103 may be expected to sum all of the numbers received from all four of the hosts 203a-d and to return the entire sum. For example, each host 203a-d may send operands to the switch 103. The operands may be received in an abitrary order. The hosts 203a-d may seek for the switch 103 to perform an operation on the operands. After using the systems and methods described herein to generate a number and use the generated number to perform stochastic rounding of a result of the operation, the switch 103 may return the stochastically rounded result. The hosts 203a-d may be enabled to reproduce the generated number assuming the order the operands were transmitted to the switch can be reproduced.

The switch 103 may be enabled also use numbers from the first set of numbers along with the other received numbers to generate the random or pseudo-random number. The method 600 could be performed by a computing system other than a switch and the numbers may not be required to be received from any host and could instead be numbers generated by the computing system through the execution of an application or process. Also, the steps illustrated in FIG. 6 may be performed in various orders. For example, the numbers received from the hosts 203a-d may be received simultaneously or in any order and the random or pseudorandom number may be generated before or after the arithmetic calculation.

Returning to the method 600, at 603 the first host 203a sends a first set of numbers to the switch 103 and are received by a port of the switch 103. The numbers sent by hosts 203 may be contents of a vector. The numbers may be FP8, FP16, or in another format. There may be, for example, eight FP8 numbers received from the first host 203. Upon being received by the port of the switch 103, the first numbers may be stored in a bus 121a of the switch 103.

The first host 203a may send the first numbers to the switch 103 as part of a request for a computation to be performed. In the example of FIG. 6, the computation is an arithmetic operation such as an add. For example, the first host 203 may send the first numbers to the switch 103 in the form of a vector and request that the switch 103 sum the numbers of the vector.

At 606, the switch 103 may perform an arithmetic operation using the first numbers and save the result in a buffer. While the method 600 describes an arithmetic operation, it should be appreciated that other methods may involve any operation or computation which may require a rounding. An arithmetic operation may be, for example, an addition in FP16 of the received numbers which may be FP8 numbers.

At 609, one or more other hosts 203 may send numbers which may be received by the switch 103. The numbers sent by the hosts may be in the form of vectors. Each vector may comprise one or more numbers. Each number comprised by each vector may be a floating point number representing a part of a stream of numbers. The numbers in a vector may be orthogonal to numbers of other vectors. The numbers of the vectors may be saved in a buffer or bus on the switch 103. The numbers on the buffer may be used to perform a floating point logical operation to generate the random or pseudorandom number to be used For stochastic rounding.

For example, a second host may send a second set of eight numbers which are stored in a bus on the switch 103, a third host may send a third set of eight numbers which are stored in a bus on the switch 103, and a fourth host may send a fourth set of eight numbers which are stored in a bus on the switch 103. As should be appreciated, the numbers from the other hosts 203 may be received by the switch at any point in time, before or after the operation at 606. As described above, the numbers sent by hosts 203 may be contents of a vector. The numbers may be FP8, FP16, or in another format. There may be, for example, eight FP8 numbers received from each host 203.

In some implementations, the switch 103 may perform an operation such as an arithmetic operation for each host, such as an add operation in FP16 and the switch 103 may save the results in a buffer. In some implementations, the switch 103 may add results of a number of different operations into one number, such as an FP16 number.

The result of the arithmetic operation performed at 606 may be required to be rounded before being returned to a host 203. For example, the host 203 may send FP8 numbers and the arithmetic operation may be performed in FP16. To return the result of the arithmetic operation in FP8, the switch 103 may need to round the FP16 result to FP8.

To perform the rounding, a seed number may be generated at 612 by the switch 103 to be used to perform stochastic rounding on the result of the arithmetic operation. The switch 103 may, for example, generate a random or pseudorandom number by using data in one or more buffers. As described above, at 609, hosts may send vectors to the switch. Each vector may comprise one or more numbers. The numbers of the vectors may be saved in a buffer. The numbers on the buffer may be used to perform a floating point logical operation to generate the random or pseudorandom number to be used for stochastic rounding.

Generating the random or pseudorandom number may be performed in a number of ways in various implementations. In some implementations, as described above, the switch 103 may select a series of numbers from one or more buses to create the random or pseudorandom number. The generation of the random or pseudorandom number may be performed in such a way that given the same set of numbers on the bus(es), the same random or pseudorandom number may be generated. This ensures the reproducibility that enables the advantages of the systems and methods described herein.

At 615, the switch 103 may use the generated random or pseudorandom number to round the result of the arithmetic operation of 606.

Stochastic rounding is a probabilistic method used in numerical computations, particularly useful when reducing the precision of numbers, such as converting from a 16-bit floating-point number (FP16) to an 8-bit floating-point number (FP8). This method involves adding a random number to the FP16 number before performing the rounding operation. The process for rounding an FP16 number to FP8 using this form of stochastic rounding can be described as follows:

To illustrate stochastic rounding in terms of rounding an FP16 number to FP8, an FP16 number may consist of one sign bit, five exponent bits, and ten mantissa bits. The FP8 format may include one sign bit, four exponent bits, and three mantissa bits. As a result, both the exponent and the mantissa bits may need to be reduced.

The random or pseudorandom number generated at 612 may be scaled appropriately to the precision level of the FP8 format. The generated number may effectively represent the uncertainty involved in truncating the FP16 number to fit into FP8.

Next, the generated number may be added to the FP16 number. After adding the generated number to the FP16 number, the resultant value may be rounded up or down. For example, if the sum exceeds a halfway point between representable FP8 values the FP16 number may be rounded up. Otherwise, the FP16 number may be rounded down. This decision is inherently stochastic because of the addition of the random or pseudorandom number. Numbers closer to the FP8 midpoint have a higher chance of rounding up, and those further away are more likely to round down.

In some implementations, executing the rounding may be performed by adjusting the mantissa of the number to be rounded. If rounding up, the mantissa of the number to be rounded may be increased in such a way that it aligns with the FP8 format. If rounding down, the excess bits of the mantissa may be truncated. The exponent may be adjusted if necessary, such as in cases where the mantissa's rounding causes it to overflow (i.e., when the exponent should be increased by one).

Finally, the rounded number may be constructed such as by combining the adjusted mantissa and exponent, along with the original sign bit. The rounded number may be in FP8 or another format depending on the original numbers received from the host 203.

At 618, the switch 103 may output the rounded number, such as by transmitting the rounded number to one or more hosts 203. The hosts 203 and/or other devices may be enabled to reproduce the random or pseudorandom number used to perform the stochastic rounding by replicating the original numbers which appeared on the bus(es) at 603 and 609.

It is to be appreciated that any feature described herein can be claimed in combination with any other feature(s) as described herein, regardless of whether the features come from the same described embodiment.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A communication system comprising one or more circuits to:
receive a plurality of numbers at a first computing system;
perform an operation on the plurality of numbers to generate a number; and
use the generated number to perform stochastic rounding of a floating point number to generate a stochastically rounded floating point number.

2. The communication system of claim 1, wherein the received plurality of numbers are orthogonal numbers.

3. The communication system of claim 1, wherein the plurality of numbers is received from one or more processing circuits, and wherein the one or more processing circuits are enabled to reproduce the generated number used to perform the stochastic rounding.

4. The communication system of claim 3, wherein the processing circuits provide the plurality of numbers during a reproducible operation.

5. The communication system of claim 1, wherein the first computing system performs a floating point operation on the plurality of numbers, a result of the floating point operation is of a higher precision than each of the received plurality of numbers, and the stochastic rounding is a rounding of the result of the floating point operation.

6. The communication system of claim 1, wherein each of the received plurality of numbers comprises a stream of bits arriving at a bus.

7. The communication system of claim 6, wherein the bus stores each of the plurality of numbers, and each of the plurality of numbers comprises multiple digits or bits.

8. The communication system of claim 1, wherein generating the number comprises reading one or more bits from each of the numbers from a bus and using a logic function to combine the one or more bits from each of the numbers.

9. The communication system of claim 1, wherein generating the number comprises reading a plurality of bits from each of the numbers from a bus and using a logic function to combine the plurality of bits from each of the numbers.

10. The communication system of claim 1, wherein generating the number comprises reading one or more bits from each of the numbers from a bus and using a using a multiplexer to combine the one or more bits from each of the numbers.

11. The communication system of claim 1, wherein the operation comprises using one or more logic gates.

12. The communication system of claim 1, wherein the operation is reproducible based on the received plurality of numbers.

13. The communication system of claim 1, wherein the operation is performed by a hardware logical circuit.

14. The communication system of claim 1, wherein the one or more circuits are further to transmit the stochastically rounded floating point number to one or more second computing systems over a communication channel.

15. The communication system of claim 1, wherein the plurality of numbers are operands received at one or more ports of the first computing system from one or more hosts in an arbitrary order, and wherein the one or more hosts are enabled to reproduce the generated number.

16. A switch comprising one or more circuits to:
receive a plurality of numbers at a first computing system;
perform an operation on the plurality of numbers to generate a number; and
use the generated number to perform stochastic rounding of a floating point number to generate a stochastically rounded floating point number.

17. The switch of claim 16, wherein the received plurality of numbers are orthogonal numbers.

18. A method of providing stochastic rounding, the method comprising:
receiving a plurality of numbers at a first computing system;
performing an operation on the plurality of numbers to generate a number; and
using the generated number to perform stochastic rounding of a floating point number to generate a stochastically rounded floating point number.

19. The method of claim 18, wherein the received plurality of numbers are orthogonal numbers.

20. The method of claim 18, wherein the plurality of numbers is received from one or more processing circuits, and wherein the one or more processing circuits are enabled to reproduce the generated number used to perform the stochastic rounding.
